(19) United States
(12) Patent Application Publication
(10) Pub. No.: US 2014/0277951 A1
(43) Pub. Date: Sep. 18, 2014

(54) VEHICLE DEVICE CONTROLLER FOR OPERATING DEVICES INSTALLED IN VEHICLE

(71) Applicant: HYUNDAI MOTOR COMPANY, Seoul (KR)

(72) Inventor: Sung Un KIM, Yongin-si (KR)

(73) Assignee: HYUNDAI MOTOR COMPANY, Seoul (KR)

(21) Appl. No.: 14/098,350

(22) Filed: Dec. 5, 2013

(30) Foreign Application Priority Data
Mar. 15, 2013 (KR) 10-2013-0027956

(51) Int. Cl. B60R 16/023

(52) U.S. Cl. CPC B60R 16/0231
USPC 701/48; 701/1

(57) ABSTRACT

A vehicle device controller and a method for operating devices installed in a vehicle can operate devices by disposing electrodes with an elastic material therebetween on a steering wheel and utilizing the amount of change in capacitance due to gripping pressure by a driver. The vehicle device controller for operating devices installed in a vehicle may include electrodes disposed on a steering wheel and changing in capacitance in accordance with grip pressure by a driver. A capacitance detector detects the capacitance of the electrodes in connection with the electrodes, and a signal processor analyzes the pattern of the grip pressure by the driver based on the change in capacitance detected by the capacitance detector and generating an operation signal corresponding to the pattern of the grip pressure. A device operator operates the corresponding function of the operation target device in response to the operation signal from the signal processor.

### CROSS-REFERENCE TO RELATED APPLICATION

This application claims the benefit of priority to Korean Patent Application No. 10-2013-0027956 filed in the Korean Intellectual Property Office on Mar. 15, 2013, the entire contents of which are incorporated herein by reference.

### TECHNICAL FIELD

The present disclosure relates to a vehicle device controller for operating devices installed in a vehicle, and more particularly, to a vehicle device controller for operating devices installed in a vehicle which can operate devices installed in a vehicle by disposing electrodes with an elastic material therebetween on a steering wheel and utilizing change in capacitance due to grip pressure by a driver.

### BACKGROUND

In general, devices operated by a driver such as an air-conditioner, a navigator, an audio and/or AVN (Audio Video Navigation) system are mounted in a vehicle.

Recently, some devices are operated by remote control to prevent interference with the driver's attention due to manually operating buttons while driving.

Remote control may be implemented by contact type or non-contact type.

Contact type allows a driver to control, for example, an audio system without having hands off from the steering wheel while driving using specific buttons disposed on the middle portion of the steering wheel. The non-contact type, for example, controls an audio system using voice recognition.

As an example of contact type, a combination structure of a steering wheel and a remote controller has been proposed in Korean Patent Publication No. 2009-0090007. According to the configuration disclosed in the publication, corresponding devices such as an audio system in a vehicle can be controlled by a combination structure of a steering wheel fixed to the steering column of the vehicle and a remote controller disposed at the portion where the steering wheel is mounted.

However, in the contact type of the related art, a driver needs to move his/her hand to manually operate the buttons on the steering wheel while driving, thus disturbing driver's sight and creating inconveniency and safety issue.

Non-contact type using voice recognition has failed to solve the above defect that there are many errors in voice recognition, depending on the operator's voice.

The information disclosed in the Background section is only for enhancement of understanding of the background of the disclosure, and therefore, may contain information that does not form the prior art that is already known in this country to a person of ordinary skill in the art.

### SUMMARY

The present disclosure has been made in an effort to provide a vehicle device controller for operating devices installed in a vehicle by disposing electrodes with an elastic material therebetween on a steering wheel and utilizing the amount of change in capacitance due to grip pressure by a driver so that the devices can be operated without distributing the driver's view while driving.

An exemplary embodiment of the present invention provides a vehicle device controller for operating devices installed in a vehicle such as an audio system, a navigator, and an air-conditioner. The controller may include electrodes disposed on a steering wheel and changing in capacitance in accordance with grip pressure by a driver. A capacitance detector is disposed to detect the capacitance of the electrodes in connection with the electrodes. A signal processor is disposed to analyze a pattern of the grip pressure by the driver based on the change in capacitance detected by the capacitance detector and generate an operation signal corresponding to the pattern of the grip pressure. A device operator operates the corresponding function of the operation target device in response to the operation signal from the signal processor.

The electrodes may be made of conductive materials arranged opposite each other with an elastic member therebetween which is a component of the steering wheel. A plurality of electrodes made of a conductive material may be disposed on the steering wheel.

An insulating gap may be formed between the electrodes.

The electrodes may increase in capacitance, as the distance between the opposite electrodes is decreased by grip pressure.

The operation target device may be an Audio Video Navigation (AVN) system. When grip pressure increase in a clockwise or counterclockwise by the drivers left hand is detected by the capacitance detector, the signal processor may generate a signal for turning up or down the channel of the AVN system.

When grip pressure increase in a clockwise or counterclockwise by the drivers right hand is detected by the capacitance detector, the signal processor may generate a signal for turning up or down the volume on the AVN system.

When the capacitance detector detects that the grip pressures by the driver's hands are simultaneously increased inward or outward with respect to the steering wheel, the signal processor may generate a signal for zooming in or out the image on the AVN system.

When the capacitance detector detects that the grip pressures by the driver's hands are simultaneously increased clockwise or counterclockwise with respect to the steering wheel, the signal processor may generate a signal for changing the mode of the AVN system.

As described above, since electrodes are disposed with an elastic material therebetween on a steering wheel, and devices installed in a vehicle can be operated by the amount of change in capacitance according to grip pressure by a driver, safely and conveniently operating the devices installed in the vehicle without distributing the driver's view while driving is achieved.

Further, the present disclosure can reduce the possibility of misrecognition by analyzing and recognizing the pattern of grip pressure.

### BRIEF DESCRIPTION OF THE DRAWINGS

FIG. 1 is a schematic diagram of a vehicle device controller for operating devices installed in a vehicle according to an exemplary embodiment of the present invention.

FIG. 2 is a detailed schematic diagram of electrodes of the vehicle device controller for operating devices installed in a vehicle according to an exemplary embodiment of the present invention.

FIG. 3 is a cross-sectional view showing a change in shape due to grip pressure on the electrodes of the vehicle device controller for operating devices installed in a vehicle according to an exemplary embodiment of the present invention.

FIG. 4 is a graph showing a change in capacitance due to grip pressure on the electrodes of the vehicle device controller for operating devices installed in a vehicle according to an exemplary embodiment of the present invention.

FIG. 5 is a diagram of an example of use of the vehicle device controller for operating devices installed in a vehicle according to an exemplary embodiment of the present invention.

### DETAILED DESCRIPTION

Hereinafter, the present disclosure will be described more fully with reference to the accompanying drawings. However, the present disclosure is not limited to the exemplary embodiments described herein and may be embodied in other ways.

Characters L and R used with the reference numerals throughout the specification mean the left and the right, respectively, if not specifically stated. Through the specification, unless explicitly described otherwise, “including” any components will be understood to imply the inclusion of other components rather than the exclusion of any other components.

FIG. 1 is a schematic diagram of a vehicle device controller for operating devices installed in a vehicle according to an exemplary embodiment of the present invention.

A vehicle device controller for operating devices installed in a vehicle controls devices, such as an audio system, a navigator, and air-conditioner, and an Audio Video Navigation (AVN) system by disposing electrodes on a steering wheel with an elastic material therebetween and utilizing the amount of change in capacitance due to grip pressure by a driver.

The vehicle device controller for operating devices installed in a vehicle may include electrodes 120 disposed on a steering wheel 100 and changing in capacitance in accordance with grip pressure by a driver. A capacitance detector 200 detects the capacitance of the electrodes 120 in connection with the electrodes 120. A signal processor 300 analyzes a pattern of the grip pressure by the driver on the basis of the change in capacitance detected by the capacitance detector 200 and generates an operation signal corresponding to the pattern of the grip pressure. A device operator 400 operates the corresponding function of the operation target device in response to the operation signal from the signal processor 300.

Referring to FIG. 2, the electrodes 120 are made of conductive materials arranged opposite each other with an elastic member 110 therebetween which is a component of the steering wheel 100.

The electrodes 120 are made of conductive materials arranged opposite each other with the elastic member 110 therebetween to generate capacitance between the conductive materials. Therefore, dielectric materials for generating a desired amount of capacitance between the conductive materials arranged opposite each other may be contained in the elastic member 110.

A plurality of electrodes made of a conductive material may be circumferentially disposed on the steering wheel 100.

An insulating gap is formed between the electrodes 120 made of a conductive material to preclude interference between the electrodes.

Referring to FIG. 3, the electrodes 120 may be increased in capacitance, as the distance between the conductive materials is decreased by the grip pressure by the user.

The capacitance detector 200 is connected to the electrodes 120 and detects the capacitance of the electrodes 120. The capacitance detector 200 may be implemented by a microprocessor operated by a predetermined program and/or hardware composed of electric and electronic parts.

The capacitance detector 200 can easily detect the capacitance of the electrodes 120 in accordance with a common capacitance detection method.

The signal processor 300 generates an operation signal corresponding to the grip pressure pattern analyzed on the basis of the capacitance detected by the capacitance detector 200. The signal processor 300 may be implemented by a microprocessor operated by a predetermined program and/or hardware composed of electric and electronic parts.

Referring to FIG. 4, when grip pressure by the driver is applied to an electrode A and applied to an electrode B, the magnitude of capacitance increases at the electrode A and then increases at the electrode B. Referring to FIG. 3, when the driver holds and twists the steering wheel 100, the distance between the corresponding opposite electrodes 120 is decreased in accordance with the magnitude of the grip pressure applied, thus increasing the capacitance of the electrodes 120.

The device operator 400 operates the corresponding function of the operation target device such as, an air-conditioner, an audio system, a navigator, and an AVN system in response to the operation signal from the signal processor 300. The device operator 400 may be installed in the operation target device.

The capacitance detector 200, the signal processor 300, and the device operator 400 may be implemented in one unit. That is, the capacitance detector 200, the signal processor 300, and the device operator 400 are implemented by one or more microprocessors operated by a predetermined program and/or hardware and the predetermined program may be composed of a series of instructions for performing the operation, as described below.

Hereinafter, the operation of a vehicle device controller for operating devices in a vehicle is described in detail with reference to the accompanying drawings.

Referring to FIG. 5(A), assuming that a device installed in a vehicle is an AVN system when a driver grips the steering wheel 100 with the left hand LH and twists it clockwise or counterclockwise, the electrodes 120 change the magnitude of capacitance sequentially in the twisting direction, and the capacitance detector 200 detects the change.

As described above, when grip pressure increase in a clockwise or counterclockwise by the driver's left hand is detected by the capacitance detector 200, the signal processor 300 generates a signal for turning up or down the channel of the AVN system, and the device operator 400 turns up or down the channel of the AVN system.

Referring to FIG. 5(B), assuming that a device installed in a vehicle is an AVN system, when a driver grips the steering wheel 100 with the right hand RH and twists it clockwise or counterclockwise, the electrodes 120 change the magnitude of capacitance sequentially in the twisting direction, and the capacitance detector 200 detects the change.

As described above, when grip pressure increase in a clockwise or counterclockwise by the driver's right hand is detected by the capacitance detector 200, the signal processor 300 generates a signal for turning up or down the volume on the AVN system, and the device operator 400 turns up or down the volume on the AVN system.

Referring to FIGS. 5(C) and 5(D), assuming that a device installed in a vehicle is an AVN system, when a driver grips the steering wheel 100 with both left and right hands and twists the steering wheel 100 inward or outward, the electrodes 120 change the magnitude of capacitance sequentially in the twisting direction, and the capacitance detector 200 detects the change.

When the capacitance detector 200 detects that the grip pressures by the driver's hands simultaneously are increased inward or outward with respect to the steering wheel 100, the signal processor 300 generates a signal for zooming in or out the image on the AVN system, and the device operator 400 may zoom in or out the image on the AVN system.

Referring to FIGS. 5(E) and 5(F), assuming that a device installed in a vehicle is an AVN system, when a driver grips the steering wheel 100 with both of the left and right hands and twists the steering wheel 100 left or right, the electrodes 120 change the magnitude of capacitance sequentially in the twisting direction, and the capacitance detector 200 detects the change.

When the capacitance detector 200 detects that the grip pressures by the driver's hands are simultaneously increased left or right with respect to the steering wheel 100, the signal processor 300 generates a signal for changing the mode of the AVN system to the left or right, and the device operator 400 may change the mode of the AVN system to the left or right.

Although the operation of an exemplary embodiment of the present invention was described above by exemplifying an AVN system as a device, the scope of the present disclosure is not construed as being limited thereto. Even if the device installed in a vehicle is not an AVN system, the operation of an exemplary embodiment of the present invention may be used for a device that requires an operation similar to the AVN system.

While the disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A vehicle device controller for operating devices installed in a vehicle including an audio system, a navigator, and an air-conditioner, the vehicle device controller comprising:
electrodes disposed on a steering wheel and changing in capacitance in accordance with grip pressure by a driver;
a capacitance detector detecting capacitance of the electrodes in connection with the electrodes;
a signal processor analyzing a pattern of the grip pressure by the driver based on the change in the capacitance detected by the capacitance detector, and generating an operation signal corresponding to the pattern of the grip pressure; and
a device operator operating a corresponding function of an operation target device in response to the operation signal from the signal processor.

2. The vehicle device controller of claim 1, wherein the electrodes are made of conductive materials, which are arranged opposite each other with an elastic member therebetween which is a component of the steering wheel, and
a plurality of electrodes made of the conductive material is disposed on the steering wheel.

3. The vehicle device controller of claim 2, wherein an insulating gap is formed between the electrodes.

4. The vehicle device controller of claim 3, wherein the electrodes increase in capacitance, as the distance between the opposite electrodes is decreased by the grip pressure.

5. The vehicle device controller of claim 3, wherein the operation target device is an AVN (Audio Video Navigation) system, and
when a clockwise or counterclockwise increase in grip pressure by a drivers left hand is detected by the capacitance detector, the signal processor generates a signal for turning up or down a channel of the AVN system.

6. The vehicle device controller of claim 3, wherein the operation target device is an AVN system, and
when a clockwise or counterclockwise increase in grip pressure by a drivers right hand is detected by the capacitance detector, the signal processor generates a signal for turning up or down a volume on the AVN system.

7. The vehicle device controller of claim 3, wherein the operation target device is an AVN system, and
when the capacitance detector detects that the grip pressures by a driver's hands are simultaneously increased inward or outward with respect to the steering wheel, the signal processor generates a signal for zooming in or out an image on the AVN system.

8. The vehicle device controller of claim 3, wherein the operation target device is an AVN system, and
when the capacitance detector detects that the grip pressures by driver's hands are simultaneously increased clockwise or counterclockwise with respect to the steering wheel, the signal processor generates a signal for changing a mode of the AVN system.

9. A vehicle device controller for operating devices installed in a vehicle, comprising:
electrodes disposed on a steering wheel and changing in capacitance in accordance with grip pressure by a driver;
a capacitance detector detecting the capacitance of the electrodes in connection with the electrodes; and
a signal processor analyzing a pattern of the grip pressure by the driver on a basis of a change in the capacitance detected by the capacitance detector and generating an operation signal corresponding to the pattern of the grip pressure.
